(19) United States
(12) Patent Application Publication
(10) Pub. No.: US 2014/0064196 A1
(43) Pub. Date: Mar. 6, 2014

(54) LAYER 2 ADDRESS MANAGEMENT IN 3 ADDRESS ONLY CAPABLE ACCESS POINTS IN NETWORKS WITH RELAYS

(71) Applicant: QUALCOMM INCORPORATED, San Diego, CA (US)

(72) Inventors: Santosh Paul Abraham, San Diego, CA (US); George Cherian, San Diego, CA (US); Jouni Malinen, Tuusula (FI); Amin Jafarian, San Diego, CA (US)

(73) Assignee: QUALCOMM Incorporated, San Diego, CA (US)

(21) Appl. No.: 13/840,990

(22) Filed: Mar. 15, 2013

Related U.S. Application Data
(60) Provisional application No. 61/695,253, filed on Aug. 30, 2012.

(51) Int. Cl. H04W 72/04

(52) U.S. Cl. CPC H04W 72/0406
USPC 370/329

(57) ABSTRACT

During uplink traffic, a map is formed between the MAC address and an upper layer identifier of each station of a communications network. When a downlink unicast packet is received, the identifier is compared to the map to select a corresponding MAC address. The packet having the selected MAC address is delivered to the station. During uplink, the MAC address of the station generating the packet is replaced with the MAC address of the relay receiving the packet. A device receiving an uplink multicast packet is assigned a temporary MAC address which remains valid during a known period. The device replaces the MAC address of the station generating the multicast packet with the temporary MAC address to generate a new packet that is transferred up the link. A downlink packet that includes the temporary MAC address and is received during the first time period is delivered as a response packet.

### CROSS-REFERENCE TO RELATED APPLICATIONS

The present application claims the benefit of U.S. Provisional Application No. 61/695,253, filed Aug. 30, 2012, entitled “SYSTEMS, APPARATUS, AND METHODS FOR RANGE EXTENSION OF WIRELESS COMMUNICATION”, the content of which is incorporated herein by reference in its entirety. The present application also claims the benefit of and is related to U.S. application Ser. No. 13/830,706, filed Mar. 14, 2013, entitled “SYSTEMS, APPARATUS, AND METHODS FOR ADDRESS FORMAT DETECTION”, the content of which is incorporated herein by reference in its entirety.

### BACKGROUND

The present application relates to computer/communications networks, and more particularly to managing addresses in such networks.

Computers and mobile electronic devices have become commonplace tools in today's world. To enable greater connectivity and facilitate their access to the Internet, such devices are often configured to join a private or public network. One conventional device for controlling traffic in a private network is an access point. An access point facilitates packet transfer to and from each computing/communication device and further connects a private network to another private network, or to a public network, such as the Internet, via a router. A router thus serves as a gateway to other private networks or the Internet. To facilitate data transfer between a computation/communication device and an access point, a wireless communication network may also include one or more relays. Controlling the amount of processing power and memory usage in devices disposed in such networks remains a challenge.

### BRIEF SUMMARY

In accordance with one embodiment of the present invention, during uplink traffic, a map is formed between the MAC address and an upper layer identifier of each station disposed in a communications network. When a downlink unicast packet is received, the upper layer identifier carried by the packet is compared to the map to identify and select a corresponding MAC address. The downlink unicast packet having the selected MAC address is subsequently delivered to the station.

In one embodiment, such a map is formed by each relay disposed in the communications network. In one embodiment, during an uplink packet transfer the MAC address of the station generating the packet is replaced with the MAC address of the relay that receives the packet. In one embodiment, the upper layer identifier is an IP address. In another embodiment, the upper layer identifier is a transaction ID.

In accordance with one embodiment of the present invention, a communication device receiving an uplink multicast packet requesting a unicast response is assigned a temporary MAC address which remains valid during a known time period. The communication device replaces the MAC address of the station that generated the uplink multicast packet with the temporary MAC address to generate a new packet that is transferred up the communication link. A downlink packet that includes the temporary MAC address and is received during the first time period is delivered as a response packet to the station that generated the multicast packet.

In one embodiment, the communication device is a relay. In one embodiment, the relay is in direct communication with an access point. In one embodiment, the temporary MAC address is selected from a pool of globally unique MAC addresses. In another embodiment, a candidate MAC address is received for temporary assignment. Thereafter, a packet is sent to the candidate MAC address. If no response is received from the candidate MAC address after several attempts during a given time period, the candidate MAC address is selected as the temporary MAC address.

### BRIEF DESCRIPTION OF THE DRAWINGS

Aspects of the disclosure are illustrated by way of example. In the accompanying figures, like reference numbers indicate similar elements, and:

FIG. 1 shows a communications network enabling communication between an access point and a multitude of stations via a multitude of relays, in accordance with one embodiment of the present invention.

FIG. 2A is an example of an uplink packet generated at a station disposed in the communications network of FIG. 1.

FIG. 2B shows the packet of FIG. 2A after being reformatted by a first relay disposed in the communications network of FIG. 1, in accordance with one embodiment of the present invention.

FIG. 2C shows the packet of FIG. 2B after being reformatted by a second relay disposed in the communications network of FIG. 1, in accordance with one embodiment of the present invention.

FIG. 2D shows a MAC frame, as known in the prior art.

FIG. 3 is an exemplary table generated by the relay receiving the packet shown in FIG. 2A, in accordance with one embodiment of the present invention.

FIG. 4A shows a downlink packet received by the second relay of the communications network of FIG. 1, in accordance with one embodiment of the present invention.

FIG. 4B shows the downlink packet of FIG. 4A after being reformatted by the second relay disposed in the communications network of FIG. 1, in accordance with one embodiment of the present invention.

FIG. 5A shows an uplink multicast packet.

FIG. 5B shows a downlink unicast response to the uplink multicast packet of FIG. 5A, in accordance with one embodiment of the present invention.

FIG. 6 is a flowchart showing a method for delivering a downlink unicast traffic, in accordance with one embodiment of the present invention.

FIG. 7 is a flowchart showing a method for delivering a unicast response to a multicast uplink traffic, in accordance with one embodiment of the present

FIG. 8 shows various components of devices forming the communications network of FIG. 1, in accordance with one embodiment of the present invention.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure.

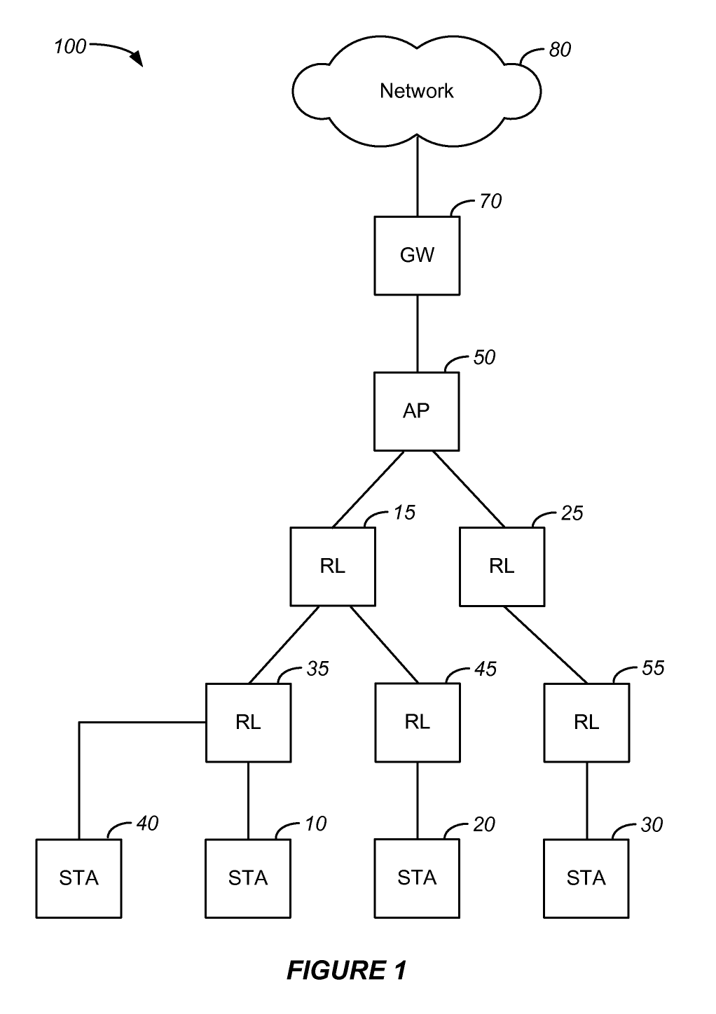

FIG. 1 shows a communications network 100 enabling communication between access point (AP) 50 and stations (STA) 10, 20, 30, 40 via relays (RL) 15, 25, 35, 45, and 55. Also shown is gateway 70 that facilitates communicates between access point 50 and network 80. Network 80 may be a private network or a public network, such as the Internet. Communication (alternatively referred to herein as packet transfer) between access point 50 and stations 10 and 30 is facilitated via relays (alternatively referred to as relay nodes) 15 and 35; packet transfer between access point 50 and station 20 is facilitated via relay nodes 15 and 45. Likewise, packet transfer between access point 50 and station 30 is facilitated via relay nodes 25 and 55. It is understood that each station may be a cellular phone, a handheld device, a laptop computer, and the like. It is understood that network 100 may be a wireless or a wired network.

A number of conventional access points can store and transmit 4 different layer-2 address fields when transferring a packet (also referred to herein as frames). Accordingly, in such access points, the source address of a requesting station is stored and kept track of as the packet is transferred up or down the communication link. Access points that do not have the capability to transmit 4 layer-2 address fields, may use the layer-3 address (IP address) of the requesting node to deliver a response back to the requesting node. However, processing packets using the layer-3 addresses is CPU (central processing unit) and memory intensive. The trend towards energy efficiency has thus brought to the fore the need to reduce CPU power consumption and memory usage of the access points. Accordingly, the newer generation of access points as well as relays may not have the capability to transmit 4 layer-2 address fields. Three address fields that are often used to transfer packets are the immediate destination address, the immediate source address, and the final destination address.

Assume an uplink unicast packet transfer from station 10 to network 80 using conventional relays that support four address fields. To accomplish this transfer, station 10 generates a packet having the following addresses in its three address fields:

A1=The MAC address of relay 35
A2=The MAC address of station 10
A3=The layer-2 address of gateway 70

Relay 35 forwards the packet it receives to relay 15 after reformatting this packet to have the following addresses in its four address fields:

A1=The MAC address of relay 15
A2=The MAC address of relay 35
A3=The layer-2 address of gateway 70
A4=The MAC address of station 10

Relay 15 forwards the packet it receives to access point 50 after reformatting this packet to have the following addresses in its four address fields:

A1=The MAC address of access point 50
A2=The MAC address of relay 15
A3=The layer-2 address of gateway 70
A4=The MAC address of station 10

Since access point 50 is assumed to support only three address fields, access point 50 processes the MAC addresses of access point 50 and relay 15 as well as the layer-2 address of gateway 70 but drops the MAC address of station 10. Accordingly, the MAC address of station 10 which originated the packet is lost.

Similar MAC address loss occurs also during uplink multicast traffic. Assume station 10 sends a multicast packet requesting a unicast response. To achieve this, station 10 generates and forwards to relay 35 a packet having the following addresses in its address fields:

A1=The MAC address of relay 35
A2=The MAC address of station 10
A3=The layer-2 multicast address

Relay 35 forwards the packet it receives to relay 15 after reformatting this packet to have the following addresses in its four address fields:

A1=The MAC address of relay 15
A2=The MAC address of relay 35
A3=The layer-2 multi-cast address
A4=The MAC address of station 10

Since access point 50 is assumed to support only three address fields, access point 50 drops the MAC address of station 10. Therefore, because the information about the original source of the packet, namely the MAC address of station 10 is lost, the unicast response to the multicast packet cannot be forwarded back to station 10.

### Downlink Unicast Traffic

To ensure that a packet bound for a station is properly delivered, in accordance with one aspect of the present invention, each relay is adapted to maintain a mapping between the MAC address of the stations with which it is configured to communicate and an upper-layer signature of each such station, as described further below.

During uplink traffic (i.e., when a packet is being transferred from a station to an access point and possibly to the another network via the gateway) each relay establishes a map between the MAC address of the stations it is in in communications with and an upper layer identifier (signature) associated with that station.

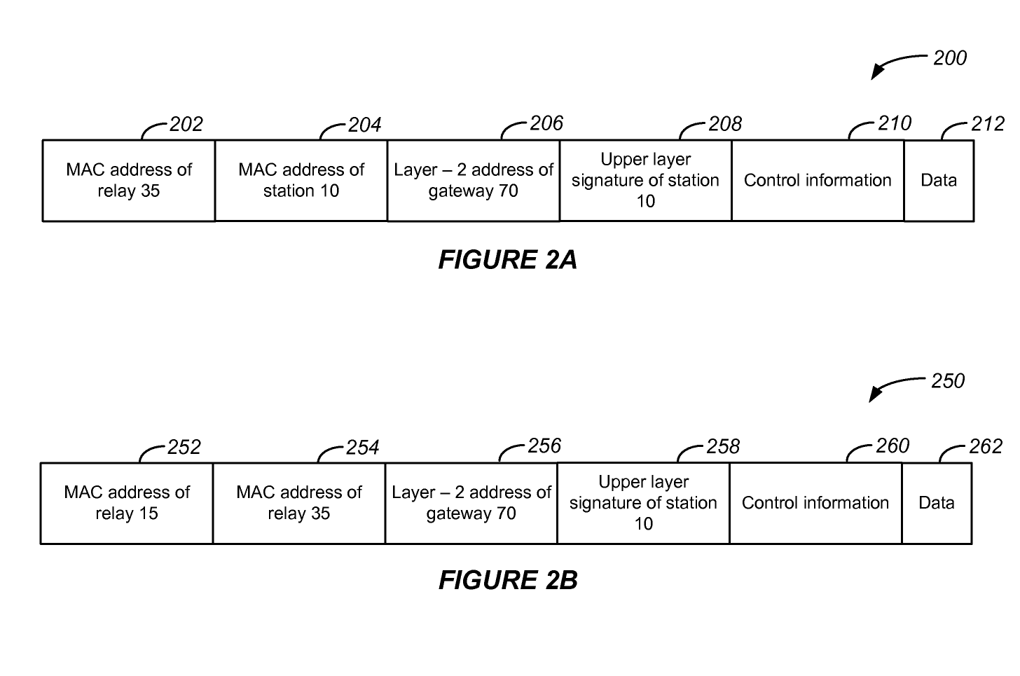

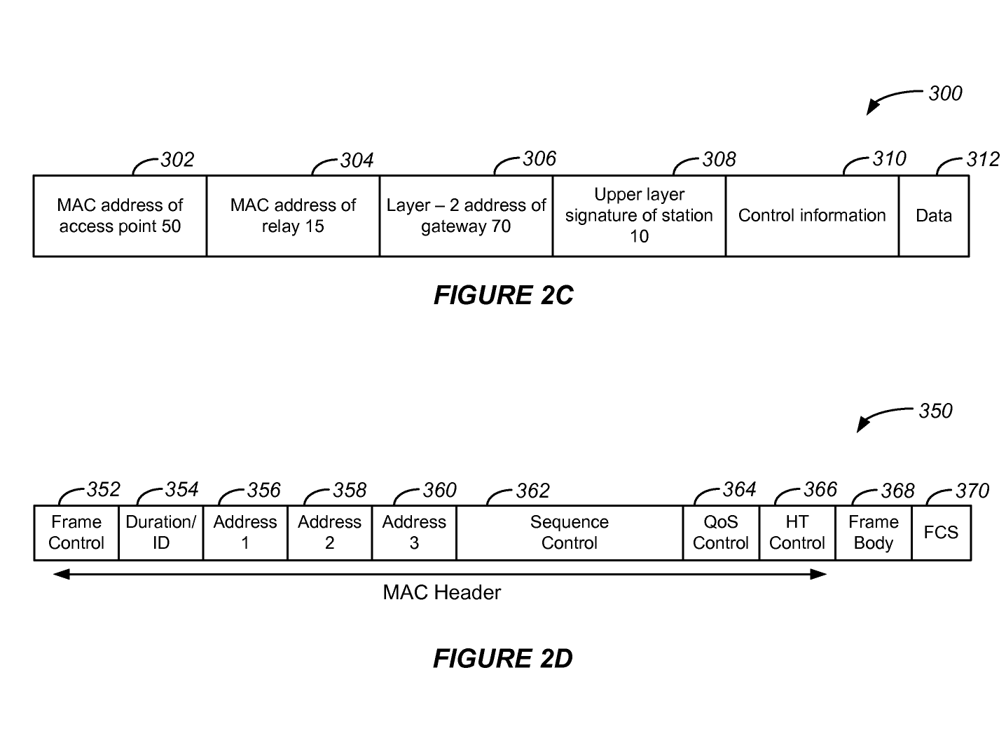

FIG. 2A is an example of a packet 200 generated at station 10 for uplink delivery to network 80. Packet 200 is shown as having, in part, an address field 202 identifying the MAC address of relay 35, address field 204 identifying the MAC address of station 10, address field 206 identifying the layer-2 address of gateway 70, and address field 208 identifying an upper layer signature of station 10. Packet 200 is also shown as including, in part, control information 210 as well as data 212. Although in the exemplary embodiment of FIG. 2A, field 208—identifying the upper layer signature—is shown as being adjacent field 206—identifying an address-2 layer—it is understood that in other embodiments, such as the http URL, TCP port number, and the like, the upper layer signature may be disposed in other frame fields not adjacent a layer-2 address field. FIG. 2D shows a MAC frame 350 that includes a frame control field 352, a duration/ID field 354, a first layer-2 address field 356, a second layer-2 address field 358, a third layer-2 address field 360, a sequence control field 362, a Quality of Service (QOS) control field 364, an HT control field 366, a frame body field 368, and a frame check sequence field 370. As is known, the upper-layer signature is disposed in frame body field 368.

Relay 35 inspects packet 200 to determine and establish a map between the MAC address of station 10 and an upper layer identifier (alternatively referred to herein as signature) of station 10, respectively shown in address fields 202 and 208 of packet 200. The upper layer signature may be, for example, an IP address associated with station 10. Relay node 35 establishes such a map for each station it is in communication with. Accordingly, for the example shown in FIG. 1, relay 35 establishes such a map for stations 10 and 40; relay 15 establishes such a map for stations 10, 20 and 40; relay 45 establishes such a map for station 20; and relay 35 establishes such a map for station 30.

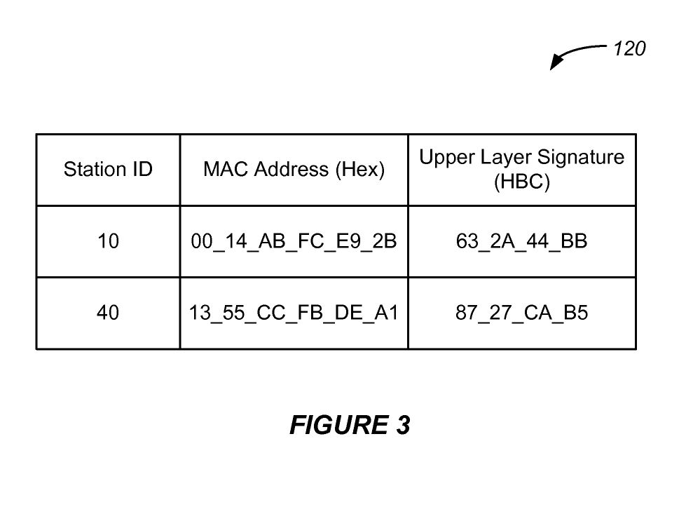

FIG. 3 is an exemplary table 120 showing the mapping generated by and stored in relay 35. Because rely 35 is assumed to be in communication with two stations, namely stations 10, 20, table 120 is shown as having two rows associated with these two stations. Station 10 is assumed to have a 48-bit MAC address of 00-14-AB-FC-E9-2B (Hex) and a 32-bit upper-layer address of 63-2A-44-BB (Hex). Station 40 is assumed to have a 48-bit MAC address of 13-55-CC-FB-DE-A1 (in Hex) and a 32-bit upper-layer address of 87-27-C4-B5. Accordingly, table 120 stored in relay 35 shows a mapping or association between the MAC address and an upper layer identifier of station 10, and an association between the MAC address and an upper layer identifier of station 40. Although not shown, it is understood that each of the other relays generates and stores a table showing such mappings/associations. In one embodiment, the upper layer signature is an IP address. If the traffic is an ARP or a DHCP traffic, another unique upper layer identifier, such as the transaction ID of the station may be used.

After forming the mapping shown in FIG. 3, to deliver packet 200 up the communication link, relay 35 replaces the MAC address of station 200 with its own MAC address to generate packet 250, as shown in FIG. 2B. Packet 250 is shown as having, in part, an address field 252 identifying the MAC address of relay 15, address field 254 identifying the MAC address of relay 35, address field 256 identifying the layer-2 address of gateway 70, and address field 258 identifying the upper layer signature of station 10. Packet 250 is also shown as including control information 260 as well as data 262. As seen from FIG. 2B, the MAC address of station 10 is no longer available for transfer up the link.

Although not shown, relay 15 generates and stores a table that provides a map between the MAC addresses of stations 10, 20, 40 and their respective upper-layer signatures in a manner similar to table 120. After forming such as map, to deliver packet 250 up the link, relay 15 generates a packer 300 as shown in FIG. 2C. Packet 300 is shown as having, in part, an address field 302 identifying the MAC address of access point 50, address field 304 identifying the MAC address of relay 15, address field 306 identifying the layer-2 address of gateway 70, and address field 308 identifying the upper layer signature of station 10. Packet 300 is also shown as including control information 310 as well as data 312. Packet 300 is subsequently transferred to the network 70 via gateway 70.

A downlink packet bound for station 10 is transferred to relay 35 via gateway 70, access point 50, and relay 15. To deliver such a packet, relay 15 compares the upper-layer signature of the received packet to its internally generated map that shows the association between the MAC address and the upper layer signatures of the stations it is connected to. The comparison identifies the MAC address of the station for which the traffic is intended. Therefore, in accordance with the present invention, by simply comparing the upper-layer signature disposed in a packet to the established mappings—and without further processing of the upper layer signature—the MAC address of the station for which a packet is intended is identified.

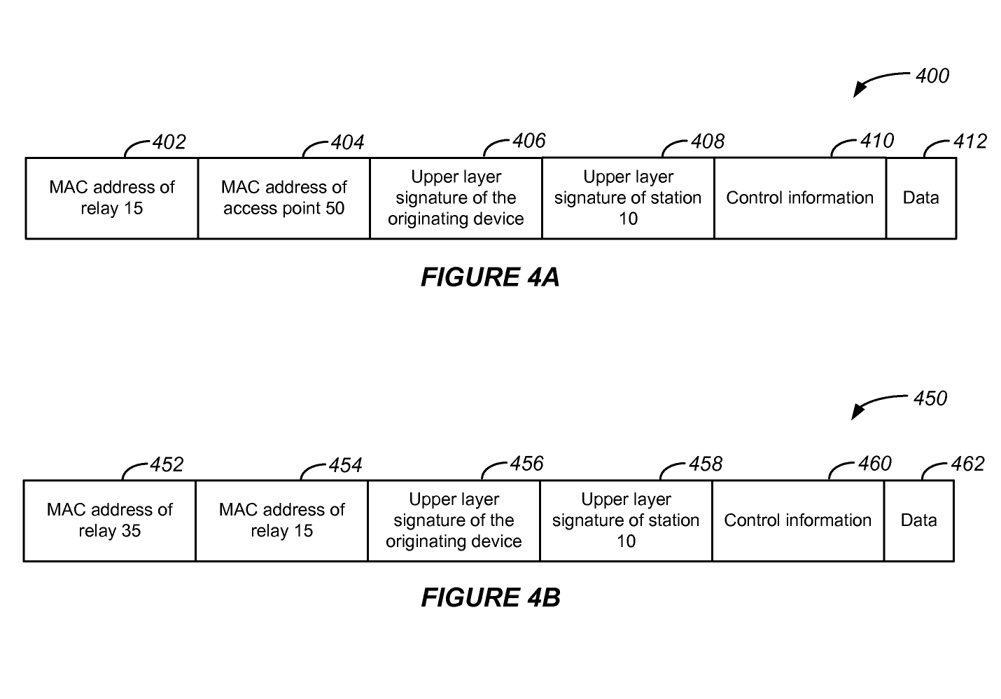

For example, assume relay 15 receives packet 400 shown in FIG. 4A. Packet 400 is shown as including, in part, an address field 402 identifying the MAC address of relay 15, address field 404 identifying the MAC address of access point 50, address field 406 identifying an upper layer signature of a device that originated packet 400, and address field 408 identifying the upper layer signature of station 10. Packet 400 is also shown as including control information 410 as well as data 412.

After receiving packet 400, relay 15 compares the upper layer signature identified in field 408 with the upper layer signatures stored in the map that relay 15 previously generated and stored, as described in detail above. For this example, the comparison identifies station 10 as the destination address, in turn causing relay 15 to generate packet 450, shown in FIG. 4B, and transfer this packet to relay 35. Packet 450 is shown as including, in part, an address field 452 identifying the MAC address of relay 35, address field 454 identifying the MAC address of relay 15, address field 456 identifying an upper layer signature of a device that originated packet 450, and address field 458 identifying the upper layer signature of station 10. In other embodiments, both the upper layer signature of the device originating the packet as well as the IP address of the destination device are disposed in the same field. In yet other embodiments, the address of the source originating the packet may not be included in downlink packets 400, 450. Packet 400 is also shown as including control information 410 as well as data 412.

After receiving packet 450, relay 35 compares the upper layer signature identified in field 458 with the upper layer signatures stored in the map that relay 35 previously generated and stored. This comparison identifies station 10 as the destination address, thus causing relay 35 to generate and transfer a corresponding packet (not shown) to station 10.

### Uplink Multicast Traffic

In accordance with another aspect of the present invention, to ensure that a unicast response to an uplink multicast traffic initiated by a station reaches that station, the relay that transfers the multicast packet to the access point is assigned an alternate and temporary MAC address that remains valid for a short time period T. The alternate MAC address serves as a portal to the requesting station during this time period.

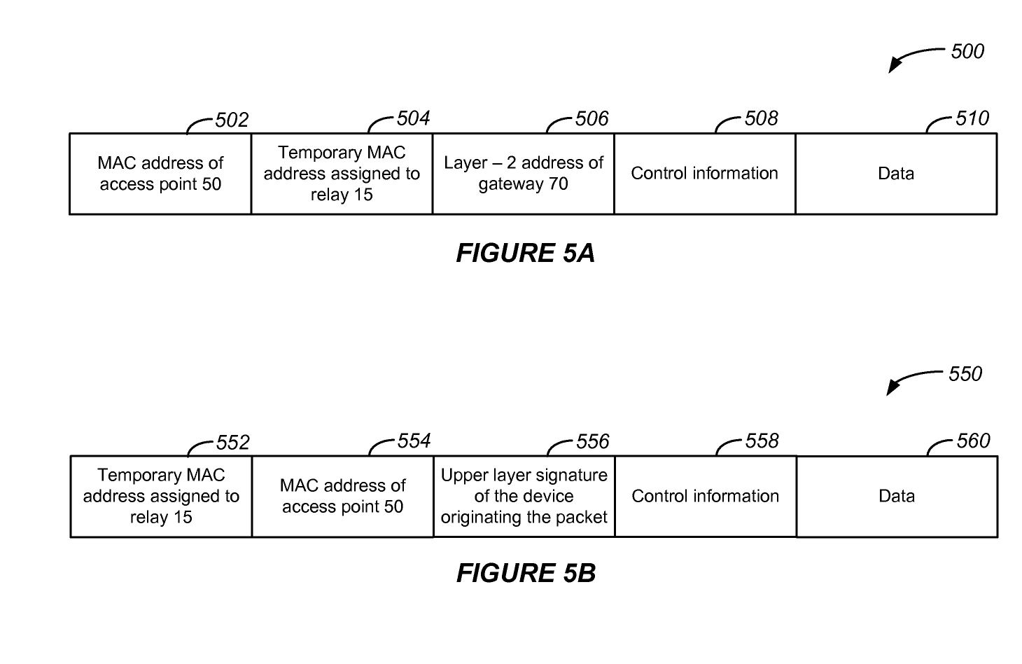

Referring to FIG. 1, assume that station 10 generates a multicast packet. Such a multicast packet is similar to packets 200 and 250 shown in FIGS. 2A and 2B, except that the multicast packet is identified as such using packet fields not shown in FIGS. 2A, 2B but well understood by those skilled in the art. During the uplink phase of the multicast traffic, relay 15 sends a multicast packet 500, shown in FIG. 5A, to access point 50. Packet 500 is shown as including, in part, an address field 502 identifying the MAC address of access point 50, address field 504 identifying the temporary MAC address of relay 15, address field 506 identifying the layer-2 address of gateway 70, control information 508 as well as data 510. It is understood that packet 500 may contain many more fields not shown in FIG. 5A for simplicity.

Assume that the temporary MAC address assigned to relay 15 is MRV1. This MAC address serves as a portal to station 10 during the temporary time period T. Furthermore in accordance with the present invention, to generate packet 500, relay 15 performs a deep inspection (not shown) of the packet it receives from relay 35 and replaces station 10's upper-layer identifier in this packet with the temporary MAC address.

In accordance with the present invention, any packet received by relay node 15 during period T that has the temporary MAC address MRV1 is forwarded to station 10. FIG. 5B shows an example of a packet 550 received by relay node 15 from access point 50. Packet 550 is shown as including, in part, an address field 552 identifying the temporary MAC address assigned to relay 50, address field 554 identifying the MAC address of access point 50, address field 556 identifying the upper layer address of the device originating the downlink unicast response to the multicast packet, control information 558 as well as data 560. It is understood that packet 550 may contain many more fields not shown in FIG. 5B for simplicity. Relay node 15 reformats packet 550 and forwards the reformatted packet to station 10.

Prior to using a candidate MAC address as the temporary MAC address (that remains valid for a known time period), relay node 15 verifies that the candidate MAC address (e.g. MVR1) is not used in the VLAN subnet that access point 50 is a part of In other words, relay 15 first verifies that relay 25 is not using MVR1 as a MAC address. In one embodiment, this verification is achieved by sending a MAC packet to the candidate address being considered for temporary assignment to the relay node. If no response is received after multiple attempts, the MAC address may be used as a temporary MAC address. In another embodiment, temporary MAC addresses may be selected from a pool of globally unique MAC addresses available for use as portal address only.

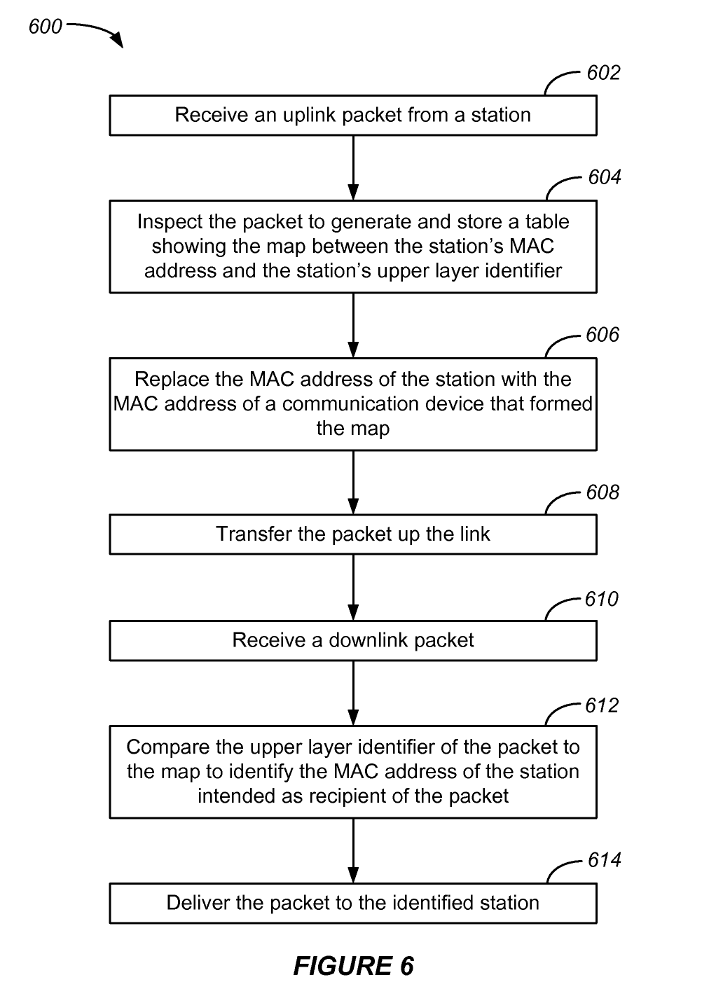

FIG. 6 is a flowchart 600 showing a method for delivering a downlink unicast traffic, in accordance with one embodiment of the present invention. To achieve this, a packet received 602 during an uplink transfer is inspected so as to generate 604 a map between the MAC address of the station that generated the packet and an upper layer identifier of the station. Subsequently, the MAC address of the station is replaced 606 in the packet with the MAC address of the communication device that generates the map. The packet is then transferred 608 up the communication link. When a downlink packet is received 610, the upper layer identifier of the packet is compared to the map to identify 612 the MAC address of the station that is the intended recipient of the packet. The packet is subsequently delivered 614 to the station so identified.

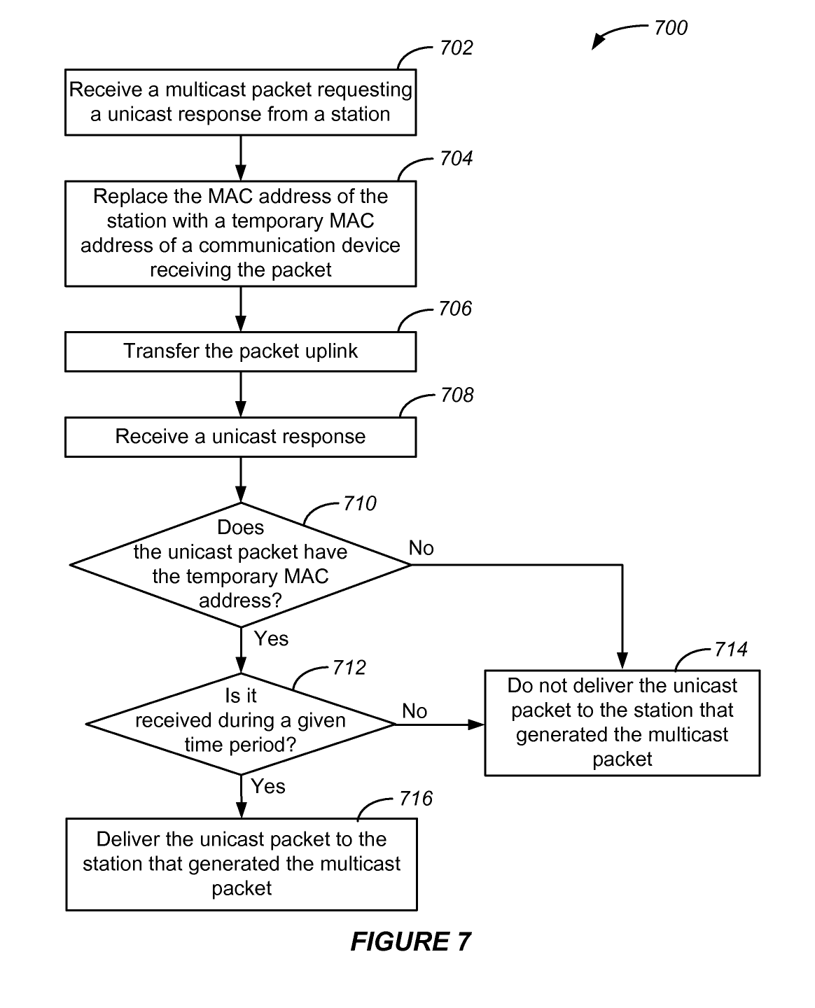

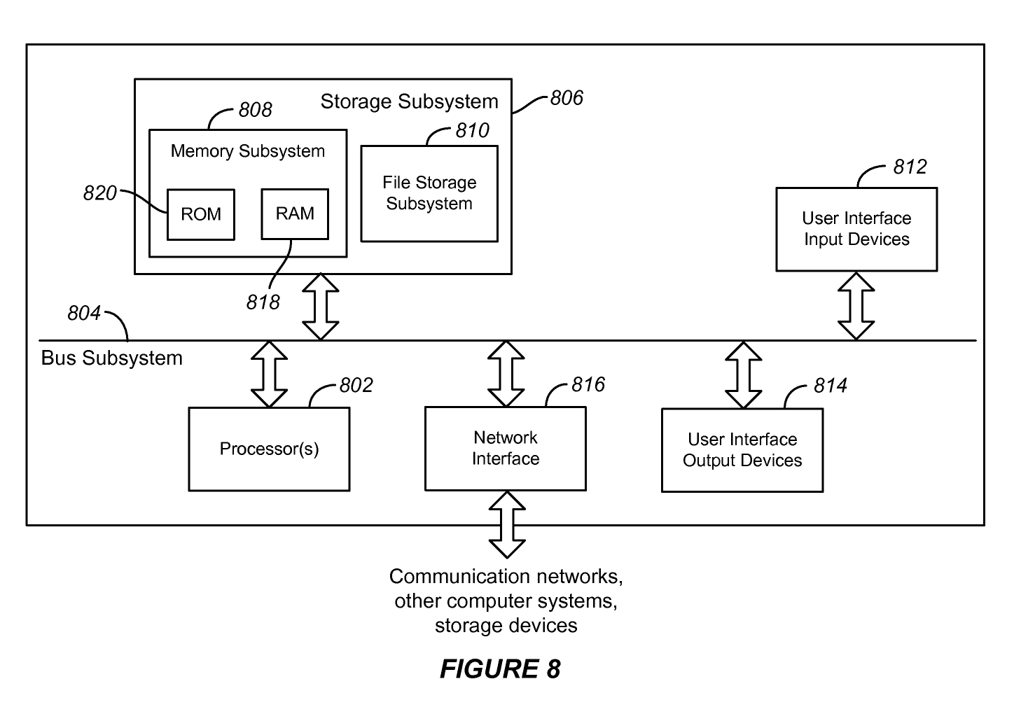

FIG. 7 is a flowchart 700 showing a method for delivering a unicast response to a multicast uplink traffic, in accordance with one embodiment of the present invention. To achieve this, a multicast packet received 702 during an uplink transfer is reformatted so as to replace 704 the MAC address of the station that generated the packet with a temporary MAC address assigned to a communication device receiving the packet. The reformatted packet is transferred 706 up the communications link. When a unicast response is received 708, the packet is inspected 710 to determine if it has the temporary MAC and further determine whether it is received 712 during a predefined time period. If the packet has the temporary MAC and is received during the predefined time period, it is delivered 716 to the station that generated the multicast request packet. Otherwise, the packet is not delivered to the station that generated the multicast request packet

FIG. 8 shows various components that may be disposed in each station, relays, access points and gateway devices of FIG. 1. Each such device is shown as including at least one processor 802, which communicates with a number of peripheral devices via a bus subsystem 804. These peripheral devices may include a storage subsystem 806, including, in part, a memory subsystem 808 and a file storage subsystem 810, user interface input devices 812, user interface output devices 814, and a network interface subsystem 616. The input and output devices allow user interaction with data processing system 802.

Network interface subsystem 816 provides an interface to other computer systems, networks, and storage resources 804. Network interface subsystem 816 serves as an interface for receiving data from other sources and for transmitting data to other sources from the processing device. Embodiments of network interface subsystem 816 include an Ethernet card, a modem (telephone, satellite, cable, ISDN, etc.), (asynchronous) digital subscriber line (DSL) units, and the like.

User interface input devices 812 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term input device is intended to include all possible types of devices and ways to input information to processing device.

User interface output devices 814 may include a display subsystem. The display subsystem may be a cathode ray tube (CRT), a flat-panel device such as a liquid crystal display (LCD), or a projection device. In general, use of the term output device is intended to include all possible types of devices and ways to output information from the processing device. Storage subsystem 806 may be configured to store the basic programming and data constructs that provide the functionality in accordance with embodiments of the present invention. For example, according to one embodiment of the present invention, software modules implementing the functionality of the present invention may be stored in storage subsystem 806 of a relay. These software modules may be executed by processor(s) 802. Storage subsystem 806 may also provide a repository for storing data used in accordance with the present invention. Storage subsystem 806 may include, for example, memory subsystem 808 and file/disk storage subsystem 810.

Memory subsystem 808 may include a number of memories including a main random access memory (RAM) 818 for storage of instructions and data during program execution and a read only memory (ROM) 820 in which fixed instructions are stored. File storage subsystem 810 provides non-volatile storage for program and data files, and may include a hard disk drive, a floppy disk drive along with associated removable media, a Compact Disk Read Only Memory (CD-ROM) drive, an optical drive, removable media cartridges, and other like storage media.

Bus subsystem 804 provides a mechanism for enabling the various components and subsystems of the processing device to communicate with each other. Although bus subsystem 804 is shown schematically as a single bus, alternative embodiments of the bus subsystem may utilize multiple busses.

The above embodiments of the present invention are illustrative and not limitative. The embodiments of the present invention are not limited by the type of station, access point, relays or gateways. The embodiments of the present invention are not limited by the type of network, communications protocol, or packets used to transfer control and data. Nor are the embodiments of the present invention limited by the upper layer signature used to establish mapping with MAC addresses. Other additions, subtractions or modifications are obvious in view of the present disclosure and are intended to fall within the scope of the appended claims.

What is claimed is:

1. A method of forwarding traffic in a communications network, the method comprising:
forming a map between a MAC address and an upper layer identifier of each of a plurality of stations of the communications network during an uplink packet transfer;
receiving a downlink unicast packet;
comparing an upper layer identifier of the downlink unicast packet to the map to select a corresponding MAC address of a station; and
delivering the downlink unicast packet to a station having the selected MAC address.

2. The method of claim 1 further comprising:
forming the map in each of a plurality of relays of the communications network.

3. The method of claim 1 further comprising:
replacing a MAC address of at least one of the stations disposed in the communications network with a MAC address of a relay in communication with the at least one station during an uplink packet transfer.

4. The method of claim 1 wherein the upper layer identifier is an IP address.

5. The method of claim 1 wherein the upper layer identifier is a transaction ID.

6. A communication device configured to:
form a map between a MAC address and an upper layer identifier of each of a plurality of stations of a communication network during an uplink packet transfer, said communication device being disposed in the communications network;
receive a downlink unicast packet;
compare an upper layer identifier of the downlink unicast packet to the map to select a corresponding MAC address of a station; and
deliver the downlink unicast packet to a station having the selected MAC address.

7. The communication device of claim 6 wherein said communication device is further configured to:
replace a MAC address of at least one of the stations disposed in the communications network with a MAC address of the communication device during an uplink packet transfer.

8. The communication device of claim 6 wherein the communication device is a relay.

9. The communication device of claim 6 wherein the upper layer identifier is an IP address.

10. The communication device of claim 6 wherein the upper layer identifier is a transaction ID.

11. A non-transitory computer readable storage medium comprising instructions that when executed by a processor cause the processor to:
form a map between a MAC address and an upper layer identifier of each of a plurality of stations of the communications network during an uplink packet transfer;
receive a downlink unicast packet;
compare an upper layer identifier of the downlink unicast packet to the map to select a corresponding MAC address of a station; and
deliver the downlink unicast packet to a station having the selected MAC address.

12. The non-transitory computer readable storage medium of claim 11 wherein said instructions further cause the processor to:
form the map in each of a plurality of relays of the communications network.

13. The non-transitory computer readable storage medium of claim 11 wherein said instructions further causes the processor to:
replace a MAC address of at least one of the stations disposed in the communications network with a MAC address of a relay in communication with the at least one station during an uplink packet transfer.

14. The non-transitory computer readable storage medium of claim 11 wherein the upper layer identifier is an IP address.

15. The non-transitory computer readable storage medium of claim 11 wherein the upper layer identifier is a transaction ID.

16. A communication device comprising:
means for forming a map between a MAC address and an upper layer identifier of each of a plurality of stations of a communications network during an uplink packet transfer, said communication device being disposed in the communications network;
means for receiving a downlink unicast packet;
means for comparing an upper layer identifier of the downlink unicast packet to the map to select a corresponding MAC address of a station; and
means for delivering the downlink unicast packet to a station having the selected MAC address.

17. The communication device of claim 16 wherein said communications device further comprises:
means for forming the map in each of a plurality of relays of the communications network.

18. The communication device of claim 16 wherein said communication device further comprises:
means for replacing a MAC address of at least one of the stations disposed in the communications network with a MAC address of a relay in communication with the at least one station during an uplink packet transfer.

19. The communication device of claim 16 wherein the upper layer identifier is an IP address.

20. The communications device of claim 16 wherein the upper layer identifier is a transaction ID.

21. A method of forwarding traffic in a communications network, the method comprising:
receiving from a station an uplink multicast packet requesting a unicast response;
assigning a temporary MAC address to a communication device in communication with the station during the uplink multicast packet delivery, said temporary MAC address to remain valid during a first time period;
replacing the station's MAC address in the uplink multicast packet with the temporary MAC address; and
delivering to the station a response packet having the assigned temporary MAC address if received during the first time period.

22. The method of claim 21 further comprising:
assigning the temporary MAC address to the communication device that is a relay.

23. The method of claim 22 wherein said communication device is in direct communication with an access point.

24. The method of claim 21 further comprising:
selecting the temporary MAC address from a pool of globally unique MAC addresses.

25. The method of claim 11 further comprising:
receiving a candidate MAC address for temporary assignment to the communication device;
sending a packet to the candidate MAC address;
waiting for a response for a second time period;
selecting the candidate MAC address as the temporary MAC address if no response is received from the candidate MAC address during the second time period.

26. A communication device configured to:
receive from a station an uplink multicast packet requesting a unicast response;
receive a temporary MAC address during an uplink multicast packet delivery, said temporary MAC address to remain valid during a first time period;
replace the station's MAC address in the uplink multicast packet with the temporary MAC address; and
deliver to the station a response packet having the assigned temporary MAC address if received during the first time period.

27. The communication device of claim 26 wherein said communication device is a relay.

28. The communication device of claim 27 wherein said communication device is in direct communications with an access point.

29. The communication device of claim 26 wherein said temporary MAC address is selected from a pool of globally unique MAC addresses.

30. The communication device of claim 26 wherein said communication device is further configured to:
receive a candidate MAC address for temporary assignment;
cause a packet to be sent to the candidate MAC address;
wait for a response for a second time period; and
accept the candidate MAC address as the temporary MAC address if no response is received from the candidate MAC address during the second time period.

31. A non-transitory computer readable storage medium comprising instructions that when executed by a processor cause the processor to:
receive from a station an uplink multicast packet requesting a unicast response;
assign a temporary MAC address to a communication device in communication with the station during the uplink multicast packet delivery, said temporary MAC address to remain valid during a first time period;
replace the station's MAC address in the uplink multicast packet with the temporary MAC address; and
deliver to the station a response packet having the assigned temporary MAC address if received during the first time period.

32. The non-transitory computer readable storage medium of claim 31 wherein said instructions further cause the processor to:
assign the temporary MAC address to the communication device that is a relay.

33. The non-transitory computer readable storage medium of claim 32 wherein said relay is in direct communications with an access point.

34. The non-transitory computer readable storage medium of claim 31 wherein said instructions further cause the processor to:
select the temporary MAC address from a pool of globally unique MAC addresses.

35. The non-transitory computer readable storage medium of claim 31 wherein said instructions further cause the processor to:
receive a candidate MAC address for temporary assignment to the communication device;
send a packet to the candidate MAC address;
wait for a response for a second time period;
select the candidate MAC address as the temporary MAC address if no response is received from the candidate MAC address during the second time period.

36. A communication device comprising:
means for receiving from a station an uplink multicast packet requesting a unicast response;
means for receiving a temporary MAC address during the uplink multicast packet delivery, said temporary MAC address to remain valid during a first time period;
means for replacing the station's MAC address in the uplink multicast packet with the temporary MAC address; and
means for delivering to the station a response packet having the assigned temporary MAC address if received during the first time period.

37. The communications device of claim 36 wherein said communication device is a relay.

38. The communication device of claim 36 wherein said node is in direct communications with an access point.

39. The communication device of claim 36 wherein said communication device further comprises:
means for selecting the temporary MAC address from a pool of globally unique MAC addresses.

40. The communication device of claim 36 wherein said communication device further comprises:
means for receiving a candidate MAC address for temporary assignment;
means for sending a packet to the candidate MAC address;
means for waiting for a response for a second time period; and
means for selecting the candidate MAC address as the temporary MAC address if no response is received from the candidate MAC address during the second time period.
